(19) United States
(12) Patent Application Publication
(10) Pub. No.: US 2005/0182051 A1
(43) Pub. Date: Aug. 18, 2005

(54) Fungicidal mixtures based on benzamidoxime derivative and a strobilurin derivative

(76) Inventors: Eberhard Ammermann, Heppenheim (DE); Reinhard Stierl, Freinsheim (DE); Gisela Lorenz, Neustadt (DE); Siegfried Strathmann, Limburgerhof (DE); Klaus Schelberger, Gonnheim (DE); Maria Scherer, Godramstein (DE); Egon Haden, Kleinniedesheim (DE)

Correspondence Address: NOVAK DRUCE DELUCA & QUIGG, LLP, 1300 EYE STREET NW, SUITE 400 EAST, WASHINGTON, DC, 20005, US

(21) Appl. No.: 10/509,110

(22) PCT Filed: Apr. 2, 2003
(86) PCT No.: PCT/EP03/03429

(30) Foreign Application Priority Data
Apr. 5, 2002 (DE) 102 15 146.6

(51) Int. Cl. A01N 43/54; A01N 43/40; A01N 43/56; A01N 37/10; A01N 37/18

(52) U.S. Cl. 514/229.2; 514/345; 514/613; 514/532; 514/406; 514/620; 514/269

(57) ABSTRACT

The invention relates to a fungicidal mixture containing (1) a benzamidoxime derivative of formula (I), whereby the substituent and the index are defined as follows: R represents hydrogen, halogen, C₁-C₄alkyl, C₁-C₄haloalkyl, C₁-C₄ alkoxy or C₁-C₄ haloalkoxy, n represents 1, 2 or 3; and at least one additional strobilurin derivative, selected from (2) a trifloxystrobin of formula (II), or (3) a picoxystrobin of formula (III), or (4) a pyraclostrobin of formula (IV), or (5) a strobilurin derivative of formula (V), or (6) a strobilurin derivative of formula (VI), or (7) a dimoxystrobin of formula (VII), or (8) a kresoxim methyl of formula (VIII), or (9) an azoxystrobin of formula (IX), or (10) a strobilurin derivative of formula (X) in a synergistically active quantity.

The present invention relates to fungicidal mixtures, comprising

(1) a benzamidoxime derivative of the formula I 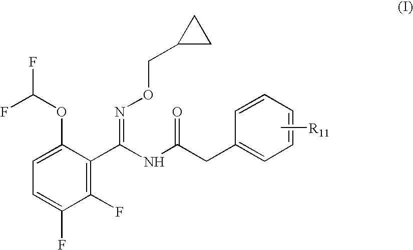
where the substituent and the index may be as defined below:
R is hydrogen, halogen, C₁-C₄-alkyl, C₁-C₄-haloalkyl, C₁-C₄-alkoxy or C₁-C₄-haloalkoxy
n 1, 2 or 3,
   and at least one strobilurin derivative, selected from

(2) trifloxystrobin of the formula II

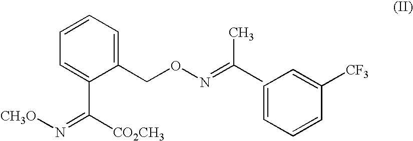

(3) picoxystrobin of the formula III 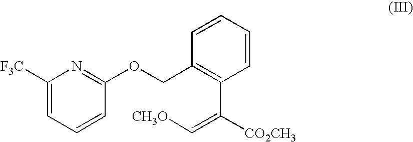
or

(4) pyraclostrobin of the formula IV

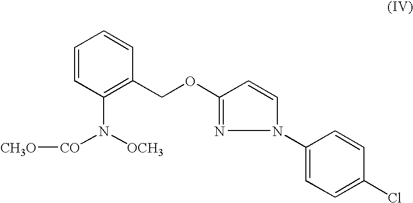

(5) a strobilurin derivative of the formula V

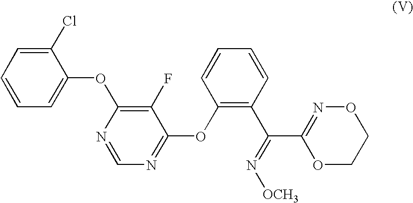

(6) a strobilurin derivative of the formula VI

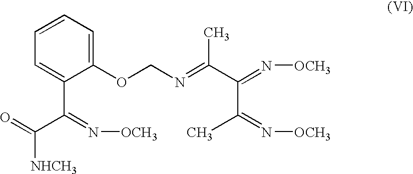

(7) dimoxystrobin of the formula VII

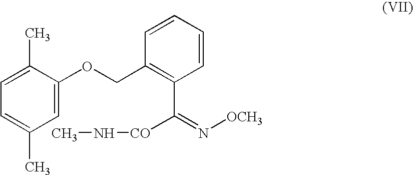

(8) kresoxim-methyl of the formula VIII

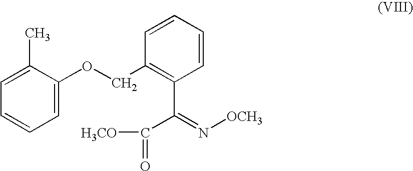

(9) azoxystrobin of the formula IX

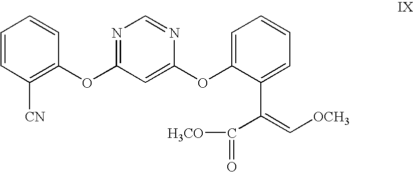

(10) a strobilurin derivative of the formula X 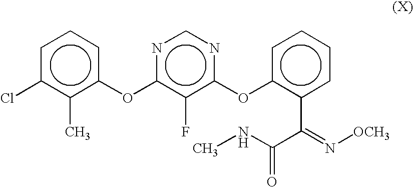
in a synergistically effective amount.

Moreover, the invention relates to a method for controlling harmful fungi using mixtures of the compounds I and at least one of the compounds II to X, to the use of the compound I and at least one of the compounds II to X for preparing such mixtures and to compositions comprising these mixtures.

The compounds of the formula I have already been disclosed in EP-A-1 017 670.

EP-A-1 017 670 discloses a number of active compound combinations of compounds of the formula I and a large number of other fungicidal compounds.

Trifloxystrobin of the formula II and its use as crop protection agent are described in EP-A-0 460 575.

Picoxystrobin is disclosed in EP-A-0 326 330.

Pyraclostrobin of the formula IV, too, has already been disclosed and is described in EP-A-0 804 421.

The strobilurin derivative of the formula V is disclosed in DE-A-196 02 095.

The strobilurin derivative of the formula VI, too, has been disclosed and is described in EP-A-0 876 332.

Dimoxystrobin of the formula VII is disclosed in EP-A-0 477 631.

Kresoxim-methyl of the formula VIII is described in EP-A-0 253 213.

Azoxystrobin of the formula IX is described in EP-A-0 382 375.

The strobilurin derivative of the formula X is disclosed in WO 98/21189 and WO 01/84931.

It is an object of the present invention to provide mixtures which, with the total amount of active compounds applied being reduced, have improved activity against harmful fungi (synergistic mixtures), with a view to reducing the application rates and improving the activity spectrum of the known compounds I to X.

We have found that this object is achieved by the mixture, defined at the outset, of a compound of the formula I and at least one strobilurin derivative of the formulae II to X. Moreover, we have found that simultaneous, that is joint or separate, application of the compound I and at least one of the compounds II to X or of the compound I and at least one of the compounds II to x in succession allows better control of harmful fungi than is possible with the individual compounds alone.

The benzamidoxime derivative of the formula I 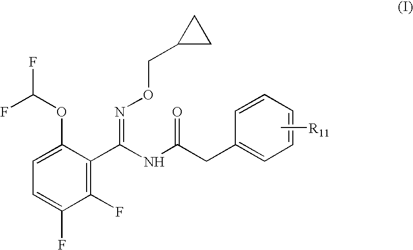
is disclosed in EP-A-1 017 670.

Trifloxystrobin of the formula II 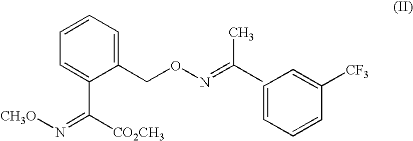
is disclosed in EP-A 0 460 572.

Picoxystrobin of the formula III 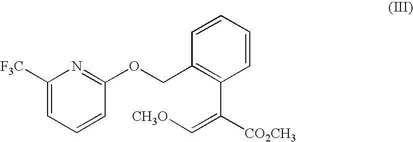
is disclosed in EP-A-0 326 330.

Pyraclostrobin of the formula IV 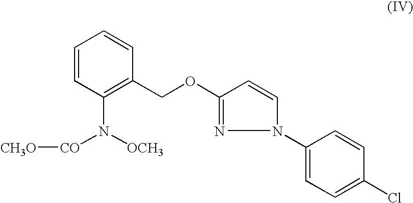
is disclosed in EP-A 0 804 421.

The strobilurin derivative of the formula V 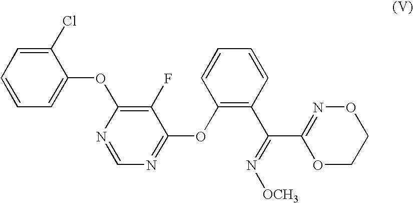
is disclosed in DE-A-196 02 095.

The strobilurin derivative of the formula VI 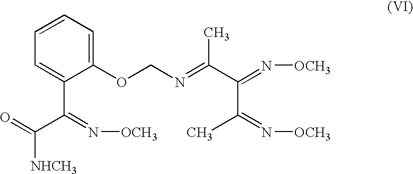
is disclosed in EP-A-0 876 332.

Dimoxystrobin of the formula VII 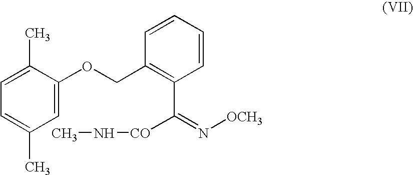
is disclosed in EP-A-0 477 631.

Kresoxim-methyl of the formula VIII 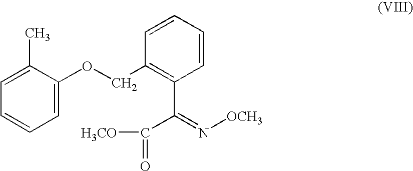
is described in EP-A-0 253 213.

Azoxystrobin of the formula IX

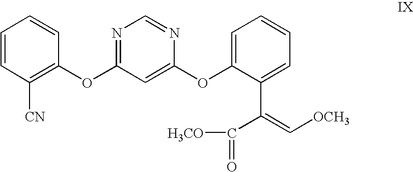

The strobilurin derivative of the formula X 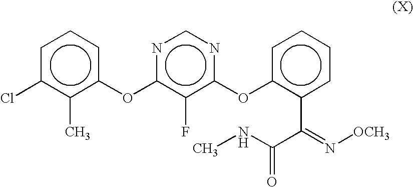
is described in EP-A-0 382 375.

In the context of the present invention, halogen is fluorine, chlorine, bromine and iodine and in particular fluorine, chlorine and bromine.

The term “alkyl” embraces straight-chain and branched alkyl groups. These are preferably straight-chain or branched C₁-C₄-alkyl groups. Examples of alkyl groups are alkyl such as, in particular, methyl, ethyl, propyl, 1-methylethyl, butyl, 1-methylpropyl, 2-methylpropyl and 1,1-dimethylethyl.

Haloalkyl is an alkyl group as defined above which is partially or fully halogenated by one or more halogen atoms, in particular fluorine and chlorine. Preferably, 1 to 3 halogen atoms are present, and the difluoromethyl and trifluoromethyl groups are particularly preferred.

What has been said above with respect to the alkyl group and the haloalkyl group applies correspondingly to the alkyl and haloalkyl groups in alkoxy and haloalkoxy.

Owing to the basic character of their nitrogen atoms, the compounds I to X are capable of forming salts or adducts with inorganic or organic acids or with metal ions.

Examples of inorganic acids are hydrohalic acids, such as hydrofluoric acid, hydrochloric acid, hydrobromic acid and hydriodic acid, and furthermore carbonic acid, sulfuric acid, phosphoric acid and nitric acid.

Suitable organic acids are, for example, formic acid, and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl radicals of 1 to 20 carbon atoms), arylsulfonic acids or aryldisulfonic acids (aromatic radicals, such as phenyl and naphthyl, which carry one or two sulfo groups), alkylphosphonic acids (phosphonic acids having straight-chain or branched alkyl radicals of 1 to 20 carbon atoms), arylphosphonic acids or aryldiphosphonic acids (aromatic radicals, such as phenyl and naphthyl, which carry one or two phosphoric acid radicals), it being possible for the alkyl or aryl radicals to carry further substituents, e.g. p-toluenesulfonic acid, salicylic acid, p-aminosalicylic acid, 2-phenoxybenzoic acid, 2-acetoxybenzoic acid, etc.

Suitable metal ions are, in particular, the ions of the elements of the second main group, in particular calcium and magnesium, of the third and fourth main group, in particular aluminum, tin and lead, and of the first to eighth transition group, in particular chromium, manganese, iron, cobalt, nickel, copper, zinc and others. Particular preference is given to the metal ions of the elements of the transition groups of the fourth period. The metals can exist in the various valences which they can assume.

Preference is given to the compound of the formula I in which R is hydrogen.

Examples of compounds of the formula I are listed in Table 1.

| | |
|---|---|
| | (I) |
| 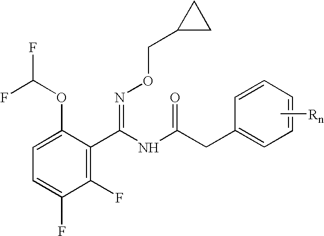 | |

| No. | R | n | m.p. ° C. |
|---|---|---|---|
| I.1 | H | 1 | 58-60 |
| I.2 | 4-F | 1 | 75-77 |
| I.3 | 4-Cl | 1 | 81-83 |
| I.4 | 4-OCH₃ | 1 | 57-59 |
| I.5 | 4-CF₃ | 1 | |

Preference is given to mixtures of a benzamidoxime derivative of the formula I with trifloxystrobin of the formula II.

Preference is also given to mixtures of a benzamidoxime derivative of the formula I with picoxystrobin of the formula III.

Preference is given to mixtures of a benzamidoxime derivative of the formula I with pyraclostrobin of the formula IV.

Preference is furthermore also given to mixtures of a benzamidoxime derivative of the formula I with a strobilurin derivative of the formula V.

Preference is furthermore also given to mixtures of a benzamidoxime derivative of the formula I with dimoxystrobin of the formula VI.

Preference is furthermore also given to mixtures of a benzamidoxime derivative of the formula I with kresoxim-methyl of the formula VII.

Preference is furthermore also given to mixtures of a benzamidoxime derivative of the formula I with azoxystrobin of the formula VIII.

Preference is also given to mixtures of a benzamidoxime derivative with the strobilurin derivative of the formula IX.

Preference is also given to mixtures of a benzamidoxime derivative with the strobilurin derivative of the formula X.

Preference is also given to three-component mixtures of a benzamidoxime derivative of the formula I with two of the abovementioned strobilurin derivatives of the formulae II to X.

When preparing the mixtures, it is preferred to employ the pure active compounds I to X, to which further active compounds against harmful fungi or other pests, such as insects, arachnids or nematodes, or else herbicidal or growth-regulating active compounds or fertilizers can be added.

The mixtures of the active compound I and at least one of the compounds II to X, or the compound I and at least one of the compounds II to X applied simultaneously, jointly or separately, exhibit outstanding activity against a wide range of phytopathogenic fungi, in particular from the classes of the Ascomycetes, Basidiomycetes, Phycomycetes and Deuteromycetes. Some of them act systemically and can therefore also be employed as folia- and soil-acting fungicides.

They are especially important for controlling a large number of fungi in a variety of crop plants, such as cotton, vegetable species (for example cucumbers, beans, tomatoes, potatoes and cucurbits), barley, grass, oats, bananas, coffee, corn, fruit species, rice, rye, soya, grapevine, wheat, ornamentals, sugarcane, and a variety of seeds.

They are particularly suitable for controlling the following phytopathogenic fungi: Blumeria graminis (powdery mildew) in cereals, Erysiphe cichoracearum and Sphaerotheca fuliginea in cucurbits, Podosphaera leucotricha in apples, Uncinula necator in grapevines, Puccinia species in cereals, Rhizoctonia species in cotton, rice and lawns, Ustilago species in cereals and sugarcane, Venturia inaequalis (scab) in apples, Helminthosporium species in cereals, Septoria nodorum in wheat, Botrytis cinera (gray mold) in strawberries, vegetables, ornamentals and grapevines, Cercospora arachidicola in groundnuts, Pseudocercosporella herpotrichoides in wheat and barley, Pyricularia oryzae in rice, Phytophthora infestans in potatoes and tomatoes, Plasmopara viticola in grapevines, Pseudoperonospora species in hops and cucumbers, Alternaria species in vegetables and fruit, Mycosphaerella species in bananas and Fusarium and Verticillium species.

The compound I and at least one of the compounds II to X can be applied simultaneously, either together or separately, or in succession, the sequence, in the case of separate application, generally not having any effect on the result of the control measures.

The compounds I and II are usually applied in a weight ratio of from 20:1 to 1:20, in particular from 10:1 to 1:10, preferably from 5:1 to 1:5.

The compounds I and III are usually applied in a weight ratio of from 20:1 to 1:20, in particular from 10:1 to 1:10, preferably from 5:1 to 1:5.

The compounds I and IV are usually applied in a weight ratio of from 20:1 to 1:20, in particular from 10:1 to 1:10, preferably from 5:1 to 1:5.

The compounds I and V are usually applied in a weight ratio of from 20:1 to 1:20, in particular from 10:1 to 1:10, preferably from 5:1 to 1:5.

The compounds I and VI are usually applied in a weight ratio of from 20:1 to 1:20, in particular from 10:1 to 1:10, preferably from 5:1 to 1:5.

The compounds I and VII are usually applied in a weight ratio of from 20:1 to 1::20, in particular from 10:1 to 1:10, preferably from 5:1to 1:5.

The compounds I and VIII are usually applied in a weight ratio of from 20:1 to 1:20, in particular from 10:1 to 1:10, preferably from 5:1 to 1:5.

The compounds I and IX are usually applied in a weight ratio of from 20:1 to 1:20, in particular from 10:1 to 1:10, preferably from 5:1 to 1:5.

The compounds I and X are usually applied in a weight ratio of from 20:1 to 1:20, in particular from 10:1 to 1:10, preferably from 5:1 to 1:5.

Depending on the kind of effect desired, the application rates of the mixtures according to the invention are, in particular in agricultural crop areas, from 0.01 to 8 kg/ha, preferably from 0.1 to 5 kg/ha, in particular from 0.1 to 3.0 kg/ha.

The application rates of the compound I are from 0.01 to 1 kg/ha, preferably from 0.05 to 0.5 kg/ha, in particular from 0.05 to 0.3 kg/ha.

Correspondingly, in the case of the compound II, the application rates are from 0.01 to 1 kg/ha, preferably from 0.02 to 0.5 kg/ha, in particular from 0.05 to 0.3 kg/ha.

Correspondingly, in the case of the compound III, the application rates are from 0.01 to 1 kg/ha, preferably from 0.02 to 0.5 kg/ha, in particular from 0.05 to 0.3 kg/ha.

Correspondingly, in the case of the compound IV, the application rates are from 0.01 to 1 kg/ha, preferably from 0.02 to 0.5 kg/ha, in particular from 0.05 to 0.3 kg/ha.

Correspondingly, in the case of the compound V, the application rates are from 0.01 to 1 kg/ha, preferably from 0.02 to 0.5 kg/ha, in particular from 0.05 to 0.3 kg/ha.

Correspondingly, in the case of the compound VI, the application rates are from 0.01 to 1 kg/ha, preferably from 0.02 to 0.5 kg/ha, in particular from 0.05 to 0.3 kg/ha.

Correspondingly, in the case of the compound VII, the application rates are from 0.01 to 1 kg/ha, preferably from 0.02 to 0.5 kg/ha, in particular from 0.05 to 0.3 kg/ha.

Correspondingly, in the case of the compound VIII, the application rates are from 0.01 to 1 kg/ha, preferably from 0.02 to 0.5 kg/ha, in particular from 0.05 to 0.3 kg/ha.

Correspondingly, in the case of the compound IX, the application rates are from 0.01 to 1 kg/ha, preferably from 0.02 to 0.5 kg/ha, in particular from 0.05 to 0.3 kg/ha.

Correspondingly, in the case of the compound X, the application rates are from 0.01 to 1 kg/ha, preferably from 0.02 to 0.5 kg/ha, in particular from 0.05 to 0.3 kg/ha.

For seed treatment, the application rates of the mixture are generally from 0.001 to 250 g/kg of seed, preferably from 0.01 to 100 g/kg, in particular from 0.01 to 50 g/kg.

If pathogenic harmful fungi are to be controlled, the separate or joint application of the compound I and at least one of the compounds II to X or of the mixtures of the compound I and at least one of the compounds II to X is effected by spraying or dusting the seeds, the plants or the soils before or after sowing of the plants, or before or after plant emergence.

The fungicidal synergistic mixtures according to the invention, or the compound I and at least one of the compounds II to X, can be formulated for example in the form of ready-to-spray solutions, powders and suspensions or in the form of highly concentrated aqueous, oily or other suspensions, dispersions, emulsions, oil dispersions, pastes, dusts, materials for broadcasting or granules, and applied by spraying, atomizing, dusting, broadcasting or watering. The use form depends on the intended purpose; in any case, it should ensure as fine and uniform as possible a distribution of the mixture according to the invention.

The formulations are prepared in a known manner, e.g. by extending the active compound with solvents and/or carriers, usually using inert additives such as emulsifiers and dispersants.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, alkyl- and alkylarylsulfonates, alkyl, lauryl ether and fatty alcohol sulfates, and salts of sulfated hexa-, hepta- and octadecanols, or of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl-or nonylphenol, alkylphenol polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methylcellulose.

Powders, materials for broadcasting and dusts can be prepared by mixing or jointly grinding the compound I and at least one of the compounds II to X, or the mixture of the compounds I and at least one of the compounds II to X, with a solid carrier.

Granules (e.g. coated granules, impregnated granules or homogeneous granules) are usually prepared by binding the active compound, or active compounds, to a solid carrier.

Fillers or solid carriers are, for example, mineral earths, such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials and fertilizers, such as ammonium sulfate, ammonium phosphate, ammonium nitrate, ureas, and products of vegetable origin, such as cereal meal, tree bark meal, wood meal and nutshell meal, cellulose powders or other solid carriers.

The formulations generally comprise from 0.1 to 95% by weight, preferably 0.5 to 90% by weight, of the compound I and at least one of the compounds II to X or of the mixture of the compound I and at least one of the compounds II to X. The active compounds are employed in a purity of from 90% to 100%, preferably 95% to 100% (according to NMR spectrum or HPLC).

The compound I and at least one of the compounds II to X, the mixtures, or the corresponding formulations, are applied by treating the harmful fungi, their habitat, or the plants, seeds, soils, areas, materials or spaces to be kept free from them with a fungicidally effective amount of the mixture, or of the compound I and at least one of the compounds II to X in the case of separate application.

Application can be effected before or after infection by the harmful fungi.

### USE EXAMPLE

The synergistic activity of the mixtures according to the invention was demonstrated by the following experiments:

The active compounds, separately or together, were formulated as a 10% emulsion in a mixture of 63% by weight of cyclohexanone and 27% by weight of emulsifier, and diluted with water to the desired concentration.

Evaluation was carried out by determining the infected leaf areas in percent. These percentages were converted into efficacies. The efficacy (w) was calculated as follows using Abbot's formula:

$$W = ( 1 - \frac{α}{β} ) \cdot 100$$

α corresponds to the fungal infection of the treated plants in % and
β corresponds to the fungal infection of the untreated (control) plants in %

An efficacy of 0 means that the infection level of the treated plants corresponds to that of the untreated control plants; an efficacy of 100 means that the treated plants were not infected.

The expected efficacies of the mixtures of the active compounds were determined using Colby's formula [R. S. Colby, Weeds 15, 20-22 (1967)] and compared with the observed efficacies.
E =x+y−x·y/100 Colby's formula:
E expected efficacy, expressed in % of the untreated control, when using the mixture of the active compounds A and B at the concentrations a and b
x efficacy, expressed in % of the untreated control, when using active compound A at a concentration of a
y efficacy, expressed in % of the untreated control, when using active compound B at a concentration of b

### Use Example 1

### Activity Against Mildew of Wheat Caused by Erysiphe [syn. Blumeria] graminis forma Specialis. tritici

Leaves of wheat seedlings of the cultivar “Kanzler” grown in pots were sprayed to runoff point with an aqueous preparation of active compound which had been prepared from a stock solution comprising 10% of active compound, 85% of cyclohexanone and 5% of emulsifier. 24 hours after the spray coating had dried on, the plants were dusted with spores of mildew of wheat (Erysiphe [syn. Blumeria] graminis forma specialis. tritici). The test plants were then placed in a greenhouse at 20-24° C. and 60-90% relative atmospheric humidity. After 7 days, the extent of the mildew development was determined visually in % infection of the entire leaf area.

The visually determined values for the percentage of infected leaf areas were converted into efficacies in % of the untreated control. An efficacy of 0 means the same degree of infection as in the untreated control, an efficacy of 100 means 0% infection. The expected efficacies for combinations of active compounds were determined using Colby's formula (Colby, S. R. (Calculating synergistic and antagonistic responses of herbicide Combinations”, Weeds, 15, p. 20-22, 1967) and compared to the observed effacacies.

TABLE 2

| | Concentration of | |
|---|---|---|
| | active | Efficacy in % |
| | compound in the spray | of the untreated |
| Active compound | liquor in ppm | control |
| Control | (94% infection) | 0 |
| (untreated) | | |
| Compound I = I.1 | 1 | 47 |
| | 0.25 | 36 |
| | 0.06 | 5 |
| Compound IV = pyraclostrobin | 1 | 0 |
| | 0.25 | 0 |
| | 0.06 | 0 |
| Compound VIII = kresoxim- | 1 | 0 |
| methyl | 0.25 | 0 |
| | 0.06 | 0 |
| Compound IX = azoxystrobin | 1 | 0 |
| | 0.25 | 0 |
| | 0.015 | 0 |

TABLE 3

| | Observed | Calculated |
|---|---|---|
| Combinations claimed | efficacy | efficacy*) |
| Compound I = I.1 + Compound | 36 | 5 |
| IV = pyraclostrobin | | |
| 0.06 + 1 ppm | | |
| mixture 1:16 | | |
| Compound I = I.1 + Compound | 25 | 5 |
| IV = pyraclostrobin | | |
| 0.06 + 0.25 ppm | | |
| mixture 1:4 | | |
| Compound I = I.1 + Compound | 79 | 47 |
| IV = pyraclostrobin | | |
| 1 + 0.25 ppm | | |
| mixture 4:1 | | |
| Compound I = I.1 + Compound | 68 | 47 |
| IV = pyraclostrobin | | |
| 1 + 0.06 ppm | | |
| mixture 16:1 | | |
| Compound I = I.1 + Compound | 25 | 5 |
| VIII = kresoxim-methyl | | |
| 0.06 + 1 ppm | | |
| mixture 1:16 | | |
| Compound I = I.1 + Compound | 25 | 5 |
| VIII = kresoxim-methyl | | |
| 0.06 + 0.25 ppm | | |
| mixture 1:4 | | |
| Compound I = I.1 + Compound | 68 | 47 |
| VIII = kresoxim-methyl | | |
| 1 + 0.25 ppm | | |
| mixture 4:1 | | |
| Compound I = I.1 + Compound | 68 | 47 |
| VIII = kresoxim-methyl | | |
| 1 + 0.06 ppm | | |
| mixture 16:1 | | |
| Compound I = I.1 + Compound | 36 | 5 |
| IX = azoxystrobin | | |
| 0.06 + 1 ppm | | |
| mixture 1:16 | | |
| Compound I = I.1 + Compound | 25 | 5 |
| IX = azoxystrobin | | |
| 0.06 + 0.25 ppm | | |
| mixture 1:4 | | |
| Compound I = I.1 + Compound | 36 | 5 |
| IX = azoxystrobin | | |
| 0.06 + 0.015 ppm | | |
| mixture 4:1 | | |
| Compound I = I.1 + Compound | 47 | 36 |
| IX = azoxystrobin | | |
| 0.25 + 0.015 ppm | | |
| mixture 16:1 | | |

*)efficacy calculated using Colby's formula

The test results show that in all mixing ratios the observed efficacy is higher than the efficacy calculated beforehand using Colby's formula (from Synerg 178. XLS).

1. A fungicidal mixture, comprising
(1) a benzamidoxime derivative of the formula I 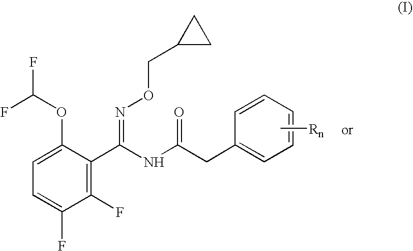
where the substituent and the index may be as defined below:
R is hydrogen, halogen, C₁-C₄-alkyl, C₁-C₄-haloalkyl, C₁-C₄-alkoxy or C₁-C₄-haloalkoxy
n 1,2or 3,
and at least one strobilurin derivative, selected from
(2) trifloxystrobin of the formula II 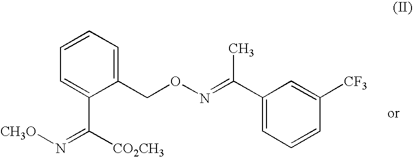
(3) picoxystrobin of the formula III 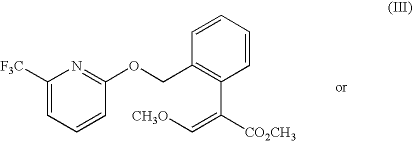
(4) pyraclostrobin of the formula IV 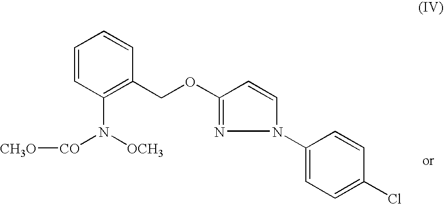
(5) a strobilurin derivative of the formula V 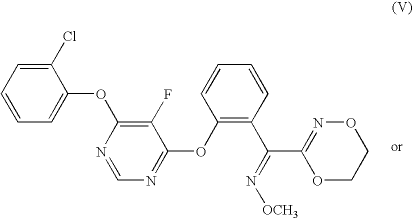
(6) a strobilurin derivative of the formula VI 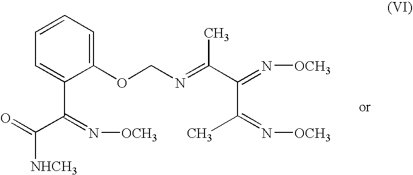
(7) dimoxystrobin of the formula VII 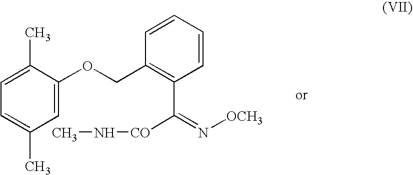
(8) kresoxim-methyl of the formula VIII 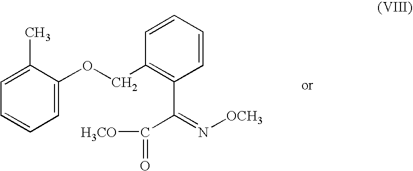
(9) azoxystrobin of the formula IX 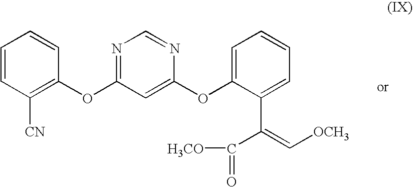
(10) a strobilurin derivative of the formula X 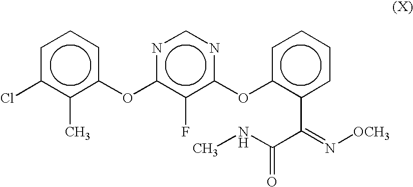
in a synergistically effective amount.

2. A fungicidal mixture as claimed in claim 1 where in the formula I the radical R is hydrogen.

3. A fungicidal mixture as claimed in claim 1, comprising a compound of the formula I and trifloxystrobin of the formula II.

4. A fungicidal mixture as claimed in claim 1, comprising a compound of the formula I and picoxystrobin of the formula III.

5. A fungicidal mixture as claimed in claim 1, comprising a compound of the formula I and pyraclostrobin of the formula IV.

6. A fungicidal mixture as claimed in claim 1, comprising a compound of the formula I and dimoxystrobin of the formula VII.

7. A fungicidal mixture as claimed in claim 1, comprising a compound of the formula I and kresoxim-methyl of the formula VII.

8. A fungicidal mixture as claimed in claim 1, comprising a compound of the formula I and strobilurin derivative of the formula VI.

9. A fungicidal mixture as claimed in claim 1, comprising a compound of the formula I and azoxystrobin of the formula IX.

10. A fungicidal mixture as claimed in claim 1, comprising a compound of the formula I and strobilurin derivative of the formula X.

11. A fungicidal mixture as claimed in claim 1, wherein the weight ratio of the compound of the formula I to the respective strobilurin derivative of the formula II to X is from 20:1 to 1:20.

12. A method for controlling harmful fungi, which comprises treating the harmful fungi, their habitat or the plants, seeds, soils, areas, materials or spaces to be kept free from them with the fungicidal mixture as claimed in claim 1.

13. A method as claimed in claim 12, wherein the compound of the formula I and at least one compound of the formula II to X are applied simultaneously, that is together or separately, or in succession.

14. A method as claimed in claim 12, wherein the fungicidal mixture or the compound of the formula I and at least one compound of the formulae II to X is/are applied in an amount of from 0.01 to 8 kg/ha.

15. A fungicidal composition, comprising the fungicidal mixture as claimed in claim 1 and a solid or liquid carrier.
